(19) United States
(12) Patent Application Publication
(10) Pub. No.: US 2020/0184516 A1
(43) Pub. Date: Jun. 11, 2020

(54) BARCODE BASED COMMUNICATION

(71) Applicant: On My Wave LLC, Santa Ana, CA (US)

(72) Inventor: David H. Bigley, Fullerton, CA (US)

(21) Appl. No.: 16/794,994

(22) Filed: Feb. 19, 2020

Related U.S. Application Data
(63) Continuation of application No. 15/389,768, filed on Dec. 23, 2016, now abandoned.
(60) Provisional application No. 62/278,203, filed on Jan. 13, 2016.

(51) Int. Cl. G06Q 30/02; H04L 12/58; G06K 7/10; G06K 7/14

(52) U.S. Cl. CPC G06Q 30/0255; H04L 51/28; H04L 61/2007; G06K 7/1417; H04L 51/10; G06K 7/10722

(57) ABSTRACT

Barcode systems and methods for person-to-person messaging, tracking, privacy, electronic gifting, and financial conversion are provided. Barcode systems related to and methods executing on a communications device of a sender and a recipient may facilitate the person-to-person messaging, tracking, privacy, electronic gifting, and financial conversion.

### CROSS-REFERENCE TO RELATED APPLICATIONS

This application is a continuation of U.S. patent application Ser. No. 15/389,768, filed Dec. 23, 2016, and entitled “SYSTEMS AND METHODS FOR CUSTOMIZING ELECTRONIC INDICIA,” which claims the benefit of U.S. Provisional Patent Application No. 62/278,203, filed Jan. 13, 2016, and entitled “BARCODE LOGIC FOR MESSAGING, TRACKING, PRIVACY, ELECTRONIC GIFTING, AND FINANCIAL CONVERSION.” The entireties of the above-noted applications are incorporated herein by reference.

### BACKGROUND

Barcodes are used to provide generic information related to an item on which the barcode is placed or an item with which the barcode is associated. The generic information provided by the barcode is intended for consumption (in a perceivable format) by a communication device configured to translate barcode information into a form readable by a person.

Similarly, a QR (Quick Response) code is essentially a two-dimensional matrix barcode that is a machine-readable code which employs an array of black and white squares, typically used for storing URLs or other information. These codes are primarily read using a camera on a mobile device such as a smartphone or tablet.

A QR code may use four standardized encoding modes to store data (or extensions may be used). The four standardized encoding modes include numeric, alphanumeric, byte/binary, and kanji (e.g., adopted logographic (each symbol represents a concept in lieu of a sound) Chinese characterizes used in the modern Japanese writing system).

Historically, the QR code system was invented in the mid-1990's. At that time, the code was primarily used in manufacturing to track vehicles within manufacturing processes. Because the code was designed to effectuate high-speed component scanning, it proved to be an efficient and effective manner by which to track products.

Today, the use of QR codes has become more widespread and is now often coupled to mobile phones and devices as a mechanism to disseminate product information and the like. Thus, opportunities exist to continue to develop new and novel associations of the QR code as the use of mobile devices (e.g., smartphones, tablets, smart watches, etc.) continue to become more prevalent in everyday life. Although various aspects may be illustrated or described with respect to a QR code, it should be understood that other types of codes or barcodes (often referred to herein simply as “codes”) may be utilized with the disclosed aspects.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

An aspect of the innovation relates to an ability to customize a QR (Quick Response) code using most any mobile device such as a smartphone, tablet, smart watch or the like. In embodiments, the customization can include associating or ‘writing on’ a QR code to personalize by attaching a video, audio, image, etc. that can be viewed by a recipient or holder of the QR code.

In other aspects, content that has been associated with a QR code can be marked private or otherwise secured so as to limit access to a particular recipient or group of recipients as desired. Further, access can be shared in some embodiments so long as an authorized recipient effects the share.

Still further embodiments employ a secure environment (e.g., application or app architecture) that further secures the ability to manage the privacy aspects of the codes and content. In examples, the environment and innovation can enable electronic gifting features and the like. Because the QR code is a unique identifier, the innovation enables the ability to track location, access, user associations and like which can be used to target advertisers or the like.

Yet other aspects provided herein relate to person-to-person messaging. Code logic (e.g., a barcode application) executing on respective communications devices of a sender and a recipient may facilitate the person-to-person messaging. A sender of a unique coded (e.g., QR, barcode) message may be able to access a unique code that may be located on a greeting card, gift card, gift tag, postcard, sticker, or other item (referred to as “item”), to attach a personal message in the form of a video, voice, photo, or other object. When the recipient of the item scans this received unique code, the recipient is able to consume (e.g., read, view, hear, watch and so on) the personal message from the sender.

Another aspect relates to tracking based on a unique code. The processes for coding and monitoring the codes (e.g., indicia (QR codes, barcodes, etc.)) and retailed item may allow the provider of the code logic (a third-party or other entity) to track what retailer has a particular card (e.g., unique QR code) and when someone (e.g., the sender) records onto that card. Further, it may allow the provider of the barcode logic (a third-party or other entity) to provide promotional advertising opportunities each time the code is read by a device. In addition, the provider of the code logic may monitor the number of cards that are sold to a particular retailer and of those cards, how many are used, as well as what those users do on the application (or logic) after using the card.

A further aspect relates to marking one or more messages and/or multi-media objects as private. In one aspect, sender may enter a recipient's cell phone number (or other identifying information) into the system (e.g., the barcode logic) as part of the process when creating and sending the message. Each user may have a sign on and pin number associated with their phone number for use in the code logic (e.g., QR code application). Only the owner of the phone number (or other identifier) and account that knows the password/pin is able to access the “private” message.

Yet another aspect relates to electronic gifting. The provider of the barcode application may allow a ‘gifter’ (e.g., a sender) to stage the delivery of multi-media (e.g., music, movies, electronic games, electronic gift card, and so on) purchases for later download by a recipient. This electronic gift box concept may be used by a sender to store purchases of multi-media until the recipient scans or activates the received code and downloads the electronic gifts onto their device. In other aspects, the electronic gifts can be downloaded at time of staging by the gifter and stored in a holding store (e.g., cloud-based store) for later delivery (e.g., upon acceptance by the recipient).

Still another aspect relates to allowing gift cards (or other items) to become cash (or another form of currency) for purchases of multi-media. Participating retailers may allow all or a portion of a gift card to be used to purchase multi-media from the electronic website (e.g., electronic store) associated with a provider of the code application or a trusted third party entity. For example, if a user likes a certain artist's song, the electronic store may be accessed as a site to purchase the music. The electronic store may operate as a satellite or branch location of a brick and mortar store and sell the electronic music, movies, games, and so forth on its platform. The profit (or portion thereof) can be later sent (or shared with) the retailer, possibly less a transaction fee. This may be used in conjunction with a “gifter” who may use their gift card to purchase an electronic item to be forwarded to a recipient via the code logic.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings in which:

FIG. 1 illustrates an example, non-limiting illustration of a workflow of code customization, according to an aspect;

FIG. 2 illustrates an example, non-limiting system configured to provide person-to-person messaging, according to an aspect;

FIG. 3 illustrates an example, non-limiting system configured to provide barcode tracking and tailored advertising, according to an aspect;

FIG. 4 illustrates an example, non-limiting system configured to privatize messages associated with a barcode, according to an aspect;

FIG. 5 illustrates an example, non-limiting system configured to facilitate electronic gifting, according to an aspect;

FIG. 6 illustrates an example, non-limiting system configured to provide financial conversion associated with one or more barcodes, according to an aspect;

FIG. 7 illustrates an example, non-limiting system that employs automated learning to facilitate one or more of the disclosed aspects;

FIG. 8 illustrates an example, non-limiting method for providing barcode logic, according to an aspect;

FIG. 9 illustrates an example, non-limiting method for processing barcode logic to allow personal messaging, according to an aspect;

FIG. 10 illustrates an example, non-limiting computer-readable medium or computer-readable device including processor-executable instructions configured to embody one or more of the aspects set forth herein; and

FIG. 11 illustrates an example, non-limiting computing environment where one or more of the aspects set forth herein are implemented.

### DETAILED DESCRIPTION

The innovation is now described with reference to the drawings. In the following description, for purposes of explanation, numerous specific details are set forth in order to provide a thorough understanding of the subject innovation. It may be evident, however, that the innovation may be practiced without these specific details. In other instances, well-known structures and devices are shown in block diagram form in order to facilitate describing the innovation.

Various aspects disclosed herein relate to the use of code logic, including an application executing on a sender's device and a recipient's device. The application may be configured to provide person-to-person messaging, tracking, privacy, electronic gifting, financial conversion as it relates to QR (Quick Response) codes, barcodes, or combinations thereof. It will be appreciated the use of the terms ‘code,’ and ‘tarcode’ are used interchangeably and meant to describe most any unique identifying image including, but, not limited to SKU-like barcodes, QR codes or other unique graphical indicia.

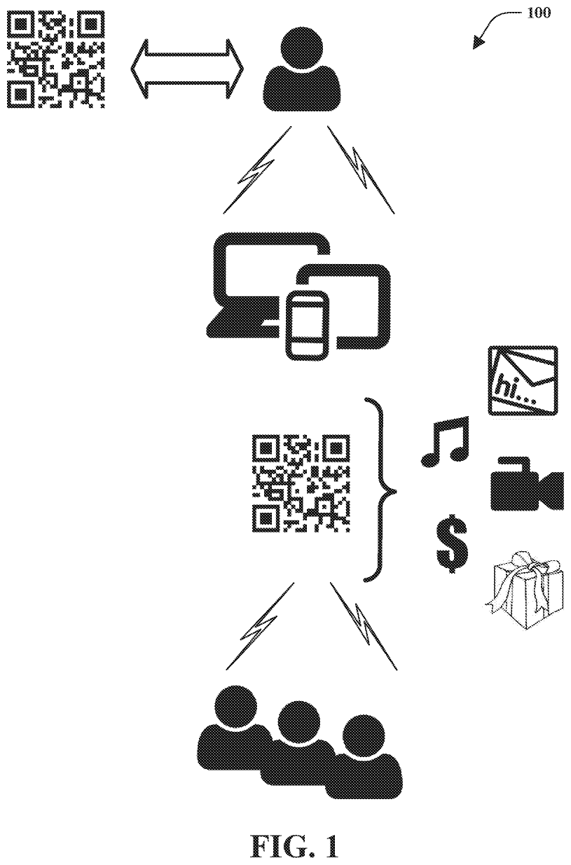

FIG. 1 illustrates an example, non-limiting illustration of a workflow 100 of code customization, according to an aspect of the innovation. Essentially, as shown in the example of FIG. 1, a user can obtain a QR code. In aspects, the QR code can be purchased (e.g., from a retailer) or otherwise custom designed (e.g., user/locally generated). In either example, once the QR code is obtained (or otherwise created) by the user, customization can occur.

As illustrated, the user (e.g., gifter, sender) can employ most any electronic device (e.g., portable device) to customize the QR code. Here, the user can ‘write on’ the QR code using most any device including but, not limited to, a smartphone, tablet, smart watch, laptop, desktop, kiosk, photo booth, or the like. It is to be understood that most any device capable of reading, scanning or otherwise capturing an image of a code (e.g., QR code) can be employed in aspects of the innovation.

Continuing with the workflow 100 illustrated in FIG. 1, the QR code can be written upon or otherwise associated with content including, but not limited to custom messages, music, audio, video, currency or other gifts. It will be appreciated upon a review of the discussion that follows infra, that the modified QR code can be privately secured to only be read or redeemed by a specific user or group of users. For instance, in one embodiment, the QR code can be specifically linked to a unique identifier associated to a user (e.g., recipient) or user's device (e.g., telephone number). These and other aspects will be described in greater detail below.

Once received, a recipient can access the content (e.g., message) or otherwise enjoy or redeem the content as appropriate. It is contemplated that the content that is custom linked or ‘written upon’ the QR code can range from private messages (e.g., text, video, audio, etc.) to currency (e.g., cash, credit, digital currency, etc.) to digital media (e.g., music, video, games, etc.). These and other aspects will become more apparent upon a reading of the description that follows below.

According to an implementation, the system 100 may be included, at least partially, on a mobile device. A mobile device may also be called, and may contain some or all of the functionality of a system, subscriber unit, subscriber station, mobile station, mobile, wireless terminal, device, remote station, remote terminal, access terminal, user terminal, terminal, wireless communication device, wireless communication apparatus, communications device, user agent, user device, or user equipment (UE). A mobile device may be a cellular telephone, a cordless telephone, a Session Initiation Protocol (SIP) phone, a smartphone, a feature phone, a wireless local loop (WLL) station, a personal digital assistant (PDA), a laptop, a handheld communication device, a handheld computing device, a netbook, a tablet, a satellite radio, a data card, a wireless modem card and/or another processing device for communicating over a wireless system.

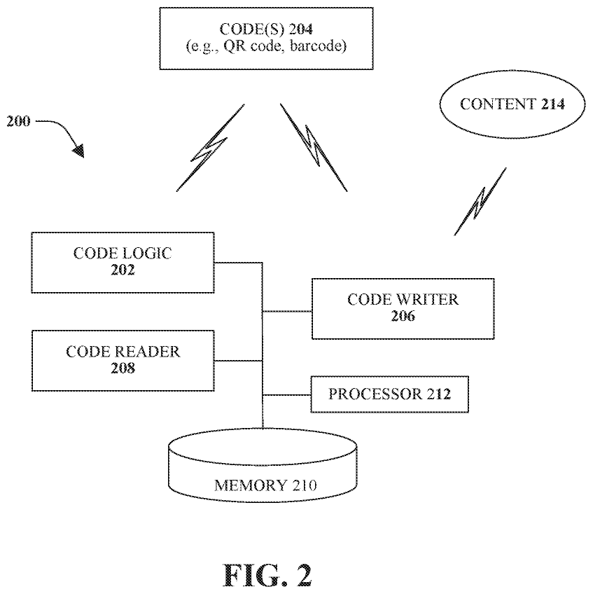

FIG. 2 illustrates an example, non-limiting system 200 configured to provide code manipulation (e.g., personalization) and person-to-person messaging, according to an aspect. A barcode is a machine-readable optical label that contains information related to an item to which the barcode is attached or to which the barcode is associated (e.g., an advertisement on a side of a bus). According to an implementation, the barcode logic may relate to a linear barcode, a one-dimensional (1D) barcode, a matrix barcode, a two-dimensional (2D) barcode, and so forth. A linear or 1D barcode generally represents data by using parallel lines with various widths and various spacing. A 2D barcode generally represents data utilizing hexagons, dots, rectangles, other geometric characters, other geometric patterns, and/or other symbols.

The system 200 may include code logic 202 that may be configured to implement, at least partially, person-to-person messaging, which allows a first user (e.g., a sender, originator, author) to ‘write on’ (e.g., record a message onto) a code 204, through utilization of a code writer 206. The message may be intended for at least a second user (e.g., a recipient). As utilized herein a user, a person, a sender, a recipient, a client, an entity, or the like, may refer to a human, an actor, a computer, the Internet, a system (or another system), a commercial enterprise, a computer, a machine, machinery, and so forth, hereinafter referred to as a user, a client, and/or an entity, depending on the context. It is to be understood that the code writer 206 functionality can include a link component (not shown) that is capable of associating an item, content, object, etc. to a particular code as desired or appropriate.

The recipient of the message may utilize (on their respective mobile device) a code reader 208 in order to receive the message represented by (or associated with) the code 204. The code reader 208 may be an optical scanner, but the disclosed aspects are not limited to this type of reader. Instead, the code reader 208 (and the code writer 206) may be implemented through the code logic 202, which may include various scanners (e.g., cameras, sensors, and so on) and/or interpretive software.

The code logic 202 may also be configured to implement tracking, privacy, electronic gifting, or financial conversion as it relates to codes, as will be discussed in further detail below.

Senders (e.g., authors, originators) of a coded message may be able to access a code on a greeting card, gift card, gift tag, postcard, sticker, and so on (referred to as item) to attach a personal message in the form of a video, audio, photo, and so on. When the recipient of the item scans or activates this received code, the recipient is able to read (or otherwise consume) the personal message from the sender. By way of example and not limitation,

According to some implementations, each code may be limited to a single message. In other words, once the code is sent it becomes read only, thus the particular barcode cannot be recorded on again. Thus, while traditional codes may be utilized by companies to send out a general (e.g., generic, preformatted) message or to direct consumers to a website, the traditional code is not used by the general public to record a message. Further, traditional code readers on phones and other devices (e.g., mobile devices) are only used to read messages, not to record or otherwise generate messages. As such, the traditional programs are only readers, there is not a write function as is provided with the various aspects disclosed herein.

In accordance with the innovation, person-to-person messaging may be facilitated on a mobile device through the barcode. Many mobile devices have the functionality to download and read a non-customized code. These codes, not customized by the sender, may be associated with various items and have very generic messages. Thus, a recipient of the code may select (e.g., click on) the code and read the general message sent to everyone. The disclosed aspects, however, allow a user to, through utilization of their mobile device, record onto (or ‘write on’) the code. Thus, each code may be further loaded with a unique message.

According to some aspects, the system may prevent re-recording on the code on which a message has been recorded. Accordingly, the system may allow for recording once on a code and then prevent anyone from recording again on that code (e.g., to not create a chain). A user that receives the code would read the code. However, according to some implementations, one or more messages may be associated with the code at substantially the same time, or at different times (e.g., a chain of messages is created). Still further, codes can be recycled, reused, timed out (e.g., based upon temporal characteristics, number of uses, or the like).

There may be a registration process. In one example, an intended sender goes to a brick-and-mortar store or electronically purchases an item (e.g., card, gift card, and so on), with a unique code built into the item, wherein the unique code communicates with a code application or the barcode logic 202.

Thus, the sender scans (e.g., creates an image of) the barcode, records their message, and the message is stored in a central database, one or more databases, in the cloud, or at some other location where the message is capable of being retrieved by a recipient. A mapping between the barcode and the message may be included in the database. Further, the mapping, information related to the barcode, the message, and other information may be retained indefinitely, or may expire after a defined interval (which may be measured from the time of purchase, the time of recording, or based on another parameter, such as last time accessed, or after an associated gift card is completely used (e.g., there is no money remaining on the card), and so on).

According to some implementations, at least one return message is permitted, wherein the recipient records a response through utilization of their respective barcode writer. In an example, a birthday card is sent with the sender singing Happy Birthday, or a video showing the person singing Happy Birthday. After the recipient listens to the recording or watches the video, the recipient may send a return message (e.g., “Thank you!”). In some implementations, the return message may be implemented through a chat (e.g., a live chat) that is opened at about the same time as the complete message has been consumed by the recipient.

In addition, the system 200 may include at least one memory 210 that may store computer executable components and/or computer executable instructions. The system 200 may also include at least one processor 212, communicatively coupled to the at least one memory 210. At least one processor 212 may facilitate execution of the computer executable components and/or the computer executable instructions stored in the at least one memory 210. The term “coupled” or variants thereof may include various communications including, but not limited to, direct communications, indirect communications, wired communications, and/or wireless communications. Further, it is to be appreciated that the content of a message can be stored locally, remotely, cloud-based or combinations thereof as illustrated by 214.

It is noted that although the one or more computer executable components and/or computer executable instructions may be illustrated and described herein as components and/or instructions separate from the at least one memory 210 (e.g., operatively connected to the at least one memory 210), the various aspects are not limited to this implementation. Instead, in accordance with various implementations, the one or more computer executable components and/or the one or more computer executable instructions may be stored in (or integrated within) the at least one memory 210. Further, while various components and/or instructions have been illustrated as separate components and/or as separate instructions, in some implementations, multiple components and/or multiple instructions may be implemented as a single component or as a single instruction. Further, a single component and/or a single instruction may be implemented as multiple components and/or as multiple instructions without departing from the example embodiments.

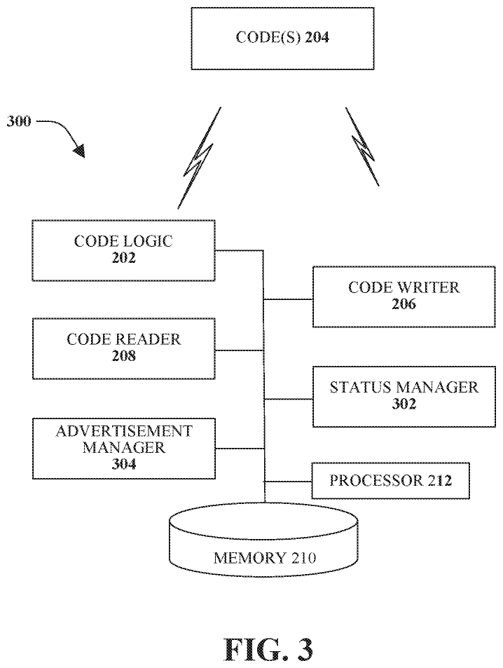

FIG. 3 illustrates an example, non-limiting system 300 configured to provide barcode tracking and tailored advertising, according to an aspect. According to an implementation, the system 300 may be included, at least partially, on a mobile device. The processes for coding and monitoring the code and the item to which it is attached may allow a provider entity (e.g., the entity that provides the code logic 202) to track which retailer has a particular card (e.g., code 204). When a sender records onto that barcode 204, the provider entity may output promotional advertising each time the barcode is read (e.g., through a barcode reader associated with the recipient). In addition, the providing entity is provided information related to the quantity of cards sold to a particular retailer and of those cards, how many are used. Further, information related to the actions the recipient performs on the application after reading, viewing, or listening to, the card may be tracked or otherwise monitored.

The system 300 may include a status manager 302 that may be configured to monitor a condition or status of the code and associated item. The condition may be not sold, sold, in transit (e.g., to a brick and mortar store), message recorded by sender, message consumed by recipient, and so on. The status manager 302 may also be configured to track a quantity of cards/codes sold for an identified retailer, how many codes have been consumed, how many (gift) cards have been used, and so on.

An advertisement manager 304 may be configured to output one or more promotional advertisements. According to an implementation, the advertisements may be tailored for the sender of the message and/or for the recipient of the message. The determination by the advertisement manager 304 as to which advertisements to output may be based upon information related to the item (e.g., retailer associated with a gift card, where the gift card was purchased, and so on) and/or information related to the message (e.g., based on keywords or phrases, based on a genre of music, and so on).

Additionally, context can be established using other sources of information, including but not limited to, social media accounts or the like so as to establish appropriate targeted advertising. For instance, a status or comment tone on a social media account can be employed to establish appropriate targeted advertising.

Additionally and in accordance with a specific example, if a sender used a code to send a birthday message, the information related to that message may be retained. The information may include a date, information related to the recipient of the birthday message, what the recipient did after consuming the message, and so on. Then, when the next birthday is expected (e.g., based on the date the first birthday message was sent, or based on confirmed date information), a notice may be output to the sender to remind them of their friend's upcoming birthday. At substantially the same time as the notice is sent, an offer to purchase the same (a similar, or a different) item as to what was purchased last year may be offered.

According to some implementations, the advertisement may be based on historical information related to the sender (or the recipient) that has been captured by the code logic 202. It is noted that in accordance with one or more implementations described in this disclosure, users may opt-out of providing personal information, demographic information, location information, proprietary information, sensitive information, or the like in connection with data gathering aspects. Moreover, one or more implementations described herein may provide for anonymizing collected, received, and/or transmitted data. Further, a user may opt-out of providing information at any time, regardless of whether the user previously opted-in to providing the information.

In some implementations, gift card purchases may be associated with the purchaser based on the method of payment (e.g., credit card, debit card, check, online payment service) or based on other information associated with the purchase (loyalty card, rewards card, club card, and so on). When the sender sends the gift card using the various aspects (e.g., using the code logic or code application), the system has information related to both the sender and something about the recipient (even before the recipient uses or logs their gift card anywhere). Thus, the system knows the sender and the recipient are connected in some way. This may provide the retailer the ability to initiate advertising prior to any use of the card. This may also allow the retailer to know who has the cards that are not being used (e.g., have not yet been redeemed, have not completely depleted of funds, and so forth).

While examples herein are directed to messaging, it will be appreciated that other content, including but not limited to, currency, gifts, games, music, movies, etc. can be written and personalized upon (or associated with) a code in other aspects. These alternative aspects are to be included with the scope of this disclosure as described herein.

Moreover, the ability to track a code based upon originator, author, programmer, purchaser, gifter, recipient, receiver, etc. is considered to be included within the scope of the innovation. As will be understood, the ability to monitor and otherwise track a code and activity associated therewith will enable an ability to build a history and intelligence around those associated therewith. Thus, friends, patterns, preferences, etc. can be built into a history therefore enabling analytics, targeted advertising and the like to be incorporated and effected as/if desired.

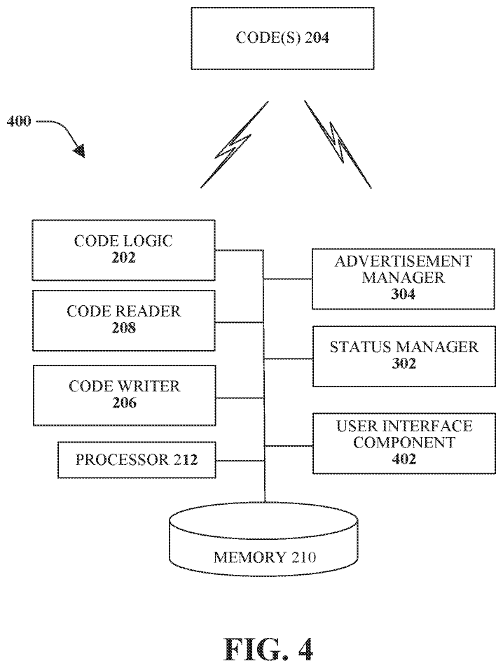

FIG. 4 illustrates an example, non-limiting system 400 configured to privatize messages associated with a code, according to an aspect. According to an implementation, the system 400 may be implemented, at least partially, on a mobile device. It is noted that although the various aspects may be discussed with respect to a single recipient, the disclosed aspects may be utilized for two or more recipients. In an implementation, the two or more recipients may be a private group of recipients.

The system 400 may include a user interface component 402 that may be configured to allow a sender to enter information related to the intended recipient(s) of the code, card, message, gift and so on. According to an implementation, the information entered may be a telephone number(s) associated with the recipient(s). However, the various aspects are not limited to a telephone number and other manners of identifying a recipient and/or a communications device associated with the recipient may be utilized.

The sender may also indicate (e.g., through the user interface component 402) that the message is confidential and should not be disclosed to others that may have access to the code. For example, if an unprotected card (or code) is discarded, lost, or otherwise obtained by someone else, that other person may be able to read the message associated with the barcode. However, if the message is marked as private or confidential, a device other than the device identified by the sender is not able to access the message.

According to some implementations, instead of consuming the message from a specific identified device, a pin number or other unique identifier may be utilized to consume the message. For example, a sender may enter a recipient's telephone number (or other identifying information) into the user interface component 402. At substantially the same time as the identifying information is entered (e.g., as a portion of creating and sending the message), the sender may mark the message as private. Each user that has the barcode logic 202 installed on their device(s) may have a sign on and pin number associated with their device(s). Thus, only the owner of the particular recipient device should have the details related to the sign on/password pair to access the barcode logic 202 (or application). When the recipient desires to consume the message, the recipient enters their unique credentials to gain access to the “private” messages. Thus, the recipient may use their laptop computer (rather than their cell phone) to obtain the message. In another implementation, a receiver may enter a pin when prompted after receiving the code 204. Conventional codes provide information that is “open” and the generic messages may be viewed by anyone that is able to access the barcode.

According to some implementations, the user interface component 402 (as well as other interface components discussed herein) may provide a graphical user interface (GUI), a command line interface, a speech interface, Natural Language text interface, and the like. For example, a GUI may be rendered that provides a user with a region or means to load, import, select, read, and so forth, various requests and may include a region to present the results of the various requests. These regions may include known text and/or graphic regions that include dialogue boxes, static controls, drop-down-menus, list boxes, pop-up menus, as edit controls, combo boxes, radio buttons, check boxes, push buttons, graphic boxes, and so on. In addition, utilities to facilitate the information conveyance, such as vertical and/or horizontal scroll bars for navigation and toolbar buttons to determine whether a region will be viewable, may be employed. Thus, it might be inferred that the user did want the action performed through the facilitating utilities.

The user may also interact with the regions to select and provide information through various devices such as a mouse, a roller ball, a keypad, a keyboard, a pen, gestures captured with a camera, a touch screen, and/or voice activation, for example. According to an aspect, a mechanism, such as a push button or the enter key on the keyboard, may be employed subsequent to entering the information in order to initiate information conveyance. However, it is to be appreciated that the disclosed aspects are not so limited. For example, merely highlighting a check box may initiate information conveyance. In another example, a command line interface may be employed. For example, the command line interface may prompt the user for information by providing a text message, producing an audio tone, or the like. The user may then provide suitable information, such as alphanumeric input corresponding to an option provided in the interface prompt or an answer to a question posed in the prompt. It is to be appreciated that the command line interface may be employed in connection with a GUI and/or API. In addition, the command line interface may be employed in connection with hardware (e.g., video cards) and/or displays (e.g., black and white, and EGA) with limited graphic support, and/or low bandwidth communication channels.

In yet other examples, a code can be marked as private merely by association to a device's (or group of approved recipient devices) ID (identification), telephone number(s), IP (internet protocol) address or the like. It will be understood that, upon receipt or attempt to read (e.g., decrypt) the code, the system 400 can interrogate the recipient's device to determine if authorization or authentication should be approved. If a match is determined, access will be permitted. Further, biometrics, passwords, PIN (personal identification numbers) or other unique identifiers can be used to secure or otherwise privatize messages.

In some aspects, it will be appreciated that access to the message or other content (e.g., media, gifts, currency) will be limited to access via the proprietary app, application, architecture or environment (not shown). In some aspects, where a card or code is sent (electronically or hardcopy) and whereby the recipient does not have an account with the appropriate reader (e.g., proprietary) app, a link (e.g., hyperlink) can be included so as to prompt download and registration by the recipient. Similarly, auto-launch mechanisms can be employed in other aspects.

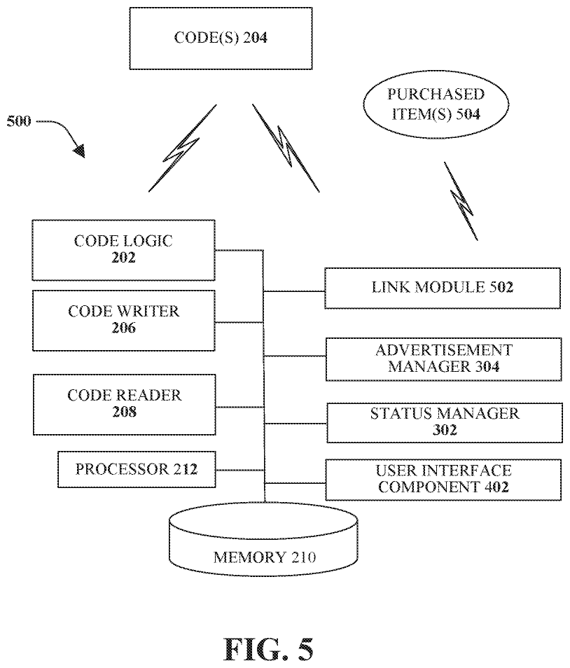

FIG. 5 illustrates yet another example, non-limiting system 500 configured to facilitate electronic gifting, according to an aspect. The sender (or gifter) may stage the delivery of multi-media (e.g., music, movies, videos, electronic games, electronic gift card, and so on) purchases for later download by a recipient. This electronic gift box concept may be used by the sender to store purchases of the multi-media until the recipient scans the received barcode and downloads the electronic gifts onto their device.

It is to be understood that, in accordance with the innovation, the ‘buy’ or actual purchase of the gift can occur at time of ‘write on’ or programming by the sender or at most any other time prior to the expiry or redemption of the gift. For instance, if an electronic download of a game or multi-media file is gifted via the code, the buy can occur immediately so as to alleviate any situation where the product is unavailable, no longer available or otherwise sold out. In these aspects, the product or purchased item can be stored (locally, distributed, cloud-based, etc.) until redeemed by the recipient. These and other aspects are to be included within the scope of this disclosure and claims appended hereto.

The system 500 may include a link module 502 that may be configured to link the barcode 204 with a purchased item 504. According to some implementations, this linking is performed at substantially the same time as the item is created (or printed). Thus, the sender is able to purchase and download various items (e.g., music, movies, electronic games, and so on). For example, a song is purchased, electronically loaded and associated with the barcode 204. At about the same time as a recipient reads the barcode, the purchased item 504 (e.g., the song in this example) is downloaded (or otherwise pushed) to the recipient's device.

In accordance with an implementation, an electronic gift card may be downloaded, preselected, or received as a gift. According to some aspects, the electronic gift card may be used in a similar manner as currency is used to make online purchases. In some aspects, a fee may be charged for use of the electronic gift card. Other aspects can include an ability to search out or otherwise locate applications that carry gift cards, like the Starbuck ‘app.’ The innovation can recognize those apps on the phone (or device) and download the value directly into the recipient's tertiary application. It will be appreciated that this process could be the same with a song downloaded from a cloud-based music store, such as iTunes. The app would place that song into the iTunes library.

Further, although multi-media or other aspects may be discussed with respect to electronic items, the aspects are not limited to this implementation. Instead, a sender may be able to stage the delivery of a physical item (e.g., a bottle of wine, a t-shirt, and so on). Included in the gift box may be a picture of the physical item (or a caricature of the physical item), a description of the item, or other information that allows the recipient to know what is in the gift box. After the recipient downloads and opens the gift box, the recipient may initiate delivery of the purchased item. In another aspect, the purchaser may choose one or more different aspects of a gift, or a different gift altogether to receive. During the activation, the recipient may select, in this example, a bottle of wine of their choosing or a particular color or size of t-shirt. In such a manner, the gift may be specifically tailored to the tastes and styles of the recipient.

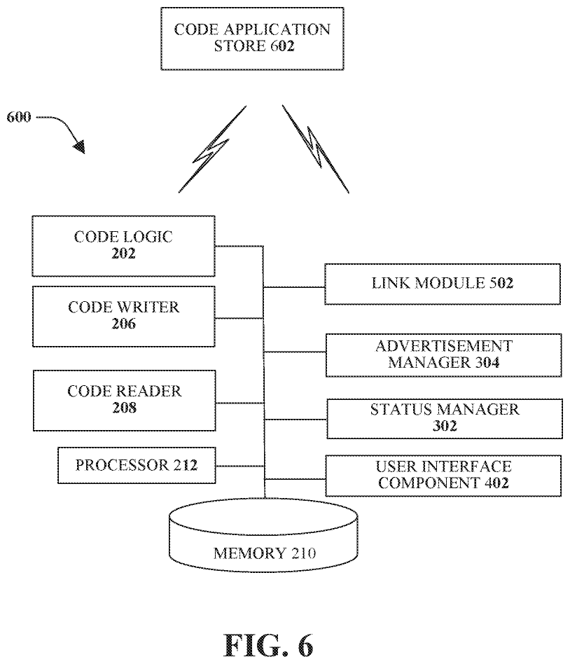

FIG. 6 illustrates an example, non-limiting system 600 configured to provide financial conversion associated with one or more barcodes, according to an aspect. Participating retailers may have all, or a portion, of a gift card be used to purchase multi-media from a barcode application store 602 (or barcode logic store). By way of example and not limitation, an envelope that may be used with the gift cards or other aspects discussed herein. Pages 5 and 6 illustrates the cards as viewed by consumers of the retailer, according to an example.

For example, a user likes a song by a certain singer/songwriter, the code application store 602 may be accessed as a place (e.g., a site) to purchase the music. The code application store 602 may operate as a back office or satellite for brick and mortar stores and/or other electronic market places. Thus, the code application store 602 may be configured to sell the electronic music, movies, games, and so on, within its platform and send the profit (or other compensation) to the retailer (less a transaction fee). This feature may be used in conjunction with a “gifter” who may use their gift card to purchase an electronic item to be forwarded to a recipient via the barcode logic.

The code application store 602 may be utilized for card/barcodes that are tied to a specific retailer. The recipient, when purchasing an item is allowed to select items offered by the specific retailer. The host of the code application store 602 retains a transaction fee and credits the specific retailer with the cost of the item. Further, the application store 602 can be branded or privately labeled with the name, logos, etc. of the retailer so as to effect a seamless user experience for the user upon redemption of the gift.

Continuing with the example, the various items (e.g., gift cards, gift tags, stickers, postcards, and so on), each with a unique code, may be sold to retailers. Communications devices belonging to customers of those retailers may have code read/write functionality. According to some implementations, the customers download and install code logic on their respective communications devices. Through use of the code logic, the customer may record a message or download a multi-media object to the code and give the item (with the item code) to a friend or other person (the recipient). When desired, the recipient reads the code, or selects a code icon in a code web application in order to perceive the message or other multi-media object.

The retailers may be customers of an entity that provides the code logic. The entity may provide each retailer a webpage or website where that retailer (e.g., employees working on behalf of the retailer, or through the use of communication devices) may obtain data related to the items sold. For example, the retailer may sign on and obtain reports, information related to how many people are using that retailer's gift cards, how many total gift cards have been used and the percentage associated with the retailer, and so on.

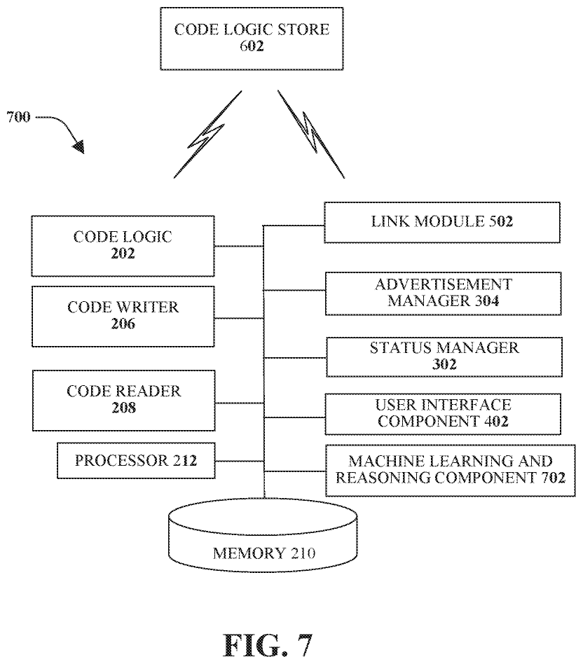

FIG. 7 illustrates an example, non-limiting system 700 that employs automated learning to facilitate one or more of the disclosed aspects. For example, a machine learning and reasoning component 702 may be utilized to automate one or more of the disclosed aspects. The machine learning and reasoning component 702 may employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the machine learning and reasoning component 702 may employ principles of probabilistic and decision theoretic inference. Additionally or alternatively, the machine learning and reasoning component 702 may rely on predictive models constructed using machine learning and/or automated learning procedures. Logic-centric inference may also be employed separately or in conjunction with probabilistic methods.

The machine learning and reasoning component 702 may infer a set of advertisements that might be suitable for a sender and/or a recipient, as discussed herein, obtain knowledge about the customer (both the sender and possibly the recipient), including historical information and current information. Based on this knowledge, the machine learning and reasoning component 702 may make an inference based on which advertisements are typical for a specific message (e.g., based on keywords or phrases in the message), for a multi-media object (e.g., what others that perceive the multi-media object do after consumption of the multi-media object), and so on. Similarly, the machine learning and reasoning component 702 can learn buying patterns, gifting patterns, timing, etc. of senders, recipients, associates, friends and the like. Utilizing some or all of the information and data, the innovation can predict and prompt actions on behalf of an entity or individual.

As used herein, the term “inference” refers generally to the process of reasoning about or inferring states of the system, a component, a module, the environment, and/or customers (or devices associated with the customers) from a set of observations as captured through events, reports, data, and/or through other forms of communication. Inference may be employed to identify a specific context or action, or may generate a probability distribution over states, for example. The inference may be probabilistic. For example, computation of a probability distribution over states of interest based on a consideration of data and/or events. The inference may also refer to techniques employed for composing higher-level events from a set of events and/or data. Such inference may result in the construction of new events and/or actions from a set of observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) may be employed in connection with performing automatic and/or inferred action in connection with the disclosed aspects.

The various aspects (e.g., in connection with providing barcode logic for messaging, tracking, privacy, electronic gifting, and financial conversion) may employ various artificial intelligence-based schemes for carrying out various aspects thereof. For example, a process for determining if a particular message is related to a birthday, anniversary, or other special occasion may be based on historical information, whether a particular advertisement should be output to either the sender and/or the recipient (or associate/friend or groups of associates/friends), whether a message should be private, which information would be useful for a retailer and, therefore, which information should be tracked may be enabled through an automatic classifier system and process.

A classifier is a function that maps an input attribute vector, x=(x1, x2, x3, x4, xn), to a confidence that the input belongs to a class. In other words, f(x)=confidence(class). Such classification may employ a probabilistic and/or statistical-based analysis (e.g., factoring into the analysis utilities and costs) to prognose or infer an action that should be employed to determine what messages associated with a barcode should be marked private, whether a particular message is suitable for the intended recipient (e.g., based on age, religion, or other social and/or demographic information), whether one or more targeted advertisements should be presented to the sender and/or recipient, how long to maintain the message and its associated code information in a database, and so on. In the case of code logic, for example, attributes may be identification of a pattern associated with messages and/or multi-media object and the classes are one or more attributes associated with each messages and/or multi-media object.

A support vector machine (SVM) (not shown) is an example of a classifier that may be employed. The SVM operates by finding a hypersurface in the space of possible inputs, which hypersurface attempts to split the triggering criteria from the non-triggering events. Intuitively, this makes the classification correct for testing data that may be similar, but not necessarily identical to training data. Other directed and undirected model classification approaches (e.g., naïve Bayes, Bayesian networks, decision trees, neural networks, fuzzy logic models, and probabilistic classification models) providing different patterns of independence may be employed. Classification as used herein, may be inclusive of statistical regression that is utilized to develop models of priority.

One or more aspects may employ classifiers that are explicitly trained (e.g., through a generic training data) as well as classifiers that are implicitly trained (e.g., by observing customer behavior, by receiving extrinsic information, and so on). For example, SVM's may be configured through a learning or training phase within a classifier constructor and feature selection module. Thus, a classifier(s) may be used to automatically learn and perform a number of functions, including but not limited to determining according to a predetermined criteria purchases that are common for a customer based on historical information, which historical purchases are anomalies and should be ignored for purposes of determining a pattern for the customer, and so forth. The criteria may include, but is not limited to, similar transactions, historical information, current information, transaction attributes, and so forth.

Additionally or alternatively, an implementation scheme (e.g., a rule, a policy, and so on) may be applied to control and/or regulate which purchases are considered to be routine and most likely non-fraudulent, and so forth. In some implementations, based upon a predefined criterion, the rules-based implementation may automatically and/or dynamically interpret attributes associated with each purchase. In response thereto, the rule-based implementation may automatically interpret and carry out functions associated with the purchases by employing a predefined and/or programmed rule(s) based upon any desired criteria.

Methods that may be implemented in accordance with the disclosed subject matter will be better appreciated with reference to the flow charts. While, for purposes of simplicity of explanation, the methods are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the disclosed methods. It is to be appreciated that the functionality associated with the blocks may be implemented by software, hardware, a combination thereof, or any other suitable means (e.g. device, system, process, component, and so forth). Additionally, it should be further appreciated that the disclosed methods are capable of being stored on an article of manufacture to facilitate transporting and transferring such methods to various devices. Those skilled in the art will understand and appreciate that the methods might alternatively be represented as a series of interrelated states or events, such as in a state diagram.

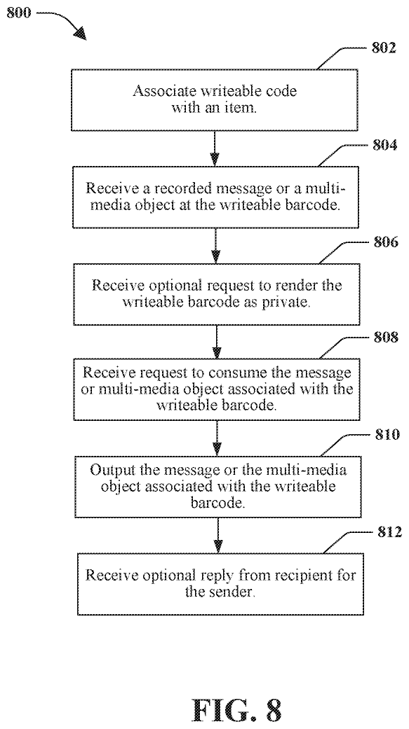

FIG. 8 illustrates an example, non-limiting method 800 for providing barcode logic, according to an aspect. The method 800 in FIG. 8 may be implemented using, for example, the systems described in FIGS. 1-7. As will be understood and appreciated, the methodology illustrated in FIG. 8 includes both the sender and receiver aspects of a process in accordance with the innovation. As such, these processes can employed by systems located at multiple physical locations.

At 802, a writeable barcode is associated with one or more items. The writeable barcode may be a one-time writable barcode, or may be a multi-time writeable (e.g., re-writable) barcode. According to some implementations, more than one person may write (e.g., associate a message or multi-media object) with the barcode. In accordance with the innovation, the writeable barcode can be, for example, a writeable QR code that is pre- or locally-printed by a user or purchased from a vendor.

When someone decides to send the item (and its associated barcode) to someone else, that person records a message or downloads a multi-media object to the barcode, at 804 (e.g., through barcode logic or a barcode application executing on a communications or mobile device). According to some implementations, the message and/or multi-media object associated with the barcode is marked at private, at 806. As described supra, the marked message can be specifically linked to a user (e.g., username, password, PIN, biometrics), user's device (e.g., phone number, IP address, MAC address), or combinations thereof, so as to secure delivery and receipt by the intended recipient.

A request to consume the message or the multi-media object associated with the barcode is received, at 808. The request may be based on a device, other than the device that was used to record the message, scanning the barcode or otherwise capturing an image of the barcode, according to an aspect. In accordance with some implementations, the message may only be output to a device that has been specifically identified, or based on a user entering valid credentials into an application running on the user's device. At about the same time (or some designated time thereafter) as the request is received, at 810, the message or multi-media object is output.

In some embodiments, at 812, one or more return messages are received. The return message(s) may be received from the recipient and may be in response to the consumed message and/or the consumed multi-media object. By way of example, the return message or notification can be sent to a sender or other designated location/address using most any protocol including, but not limited to, text message (e.g., SMS), multi-media message (e.g., MMS), instant message, electronic mail (e.g., email) or the like.

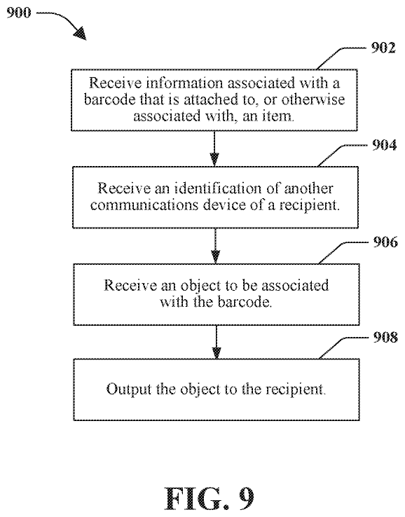

FIG. 9 illustrates an example, non-limiting method 900 for processing barcode logic to allow personal messaging, according to an aspect. At 902, information associated with a barcode attached to, or otherwise associated with, an item is received. The information may be received from a communication device of a sender (e.g. a consumer).

At 904, an identification of another communications device of a recipient is received (e.g., from the communications device of the sender). The identification may include a phone number of the recipient's communications device or another identification that is unique to the recipient's communications device. The recipient may be another consumer. According to some implementations, at substantially the same time as the identification is received, an indication of privacy issues may be received (not shown).

Further, at 906, an object to be associated with the barcode is received (e.g., from the communication device of the sender). The object may be a message, a multi-media object, and so on. For example, the object may be a voice message or other audio file. In another example, the object may be a multi-media object purchased by the sender and associated with the barcode.

At 908, the object is output to the recipient based on a determination that the recipient desires to consume the object. If there is a privacy issue, the object may be output based on a determination that the receiving device is the identified communications device (or valid user credentials were entered) that is attempting to access the object.

One or more implementations may include a computer-readable medium including microprocessor or processor-executable instructions configured to implement one or more embodiments presented herein. As discussed herein the various aspects enable barcode logic for messaging, tracking, privacy, electronic gifting, and financial conversion.

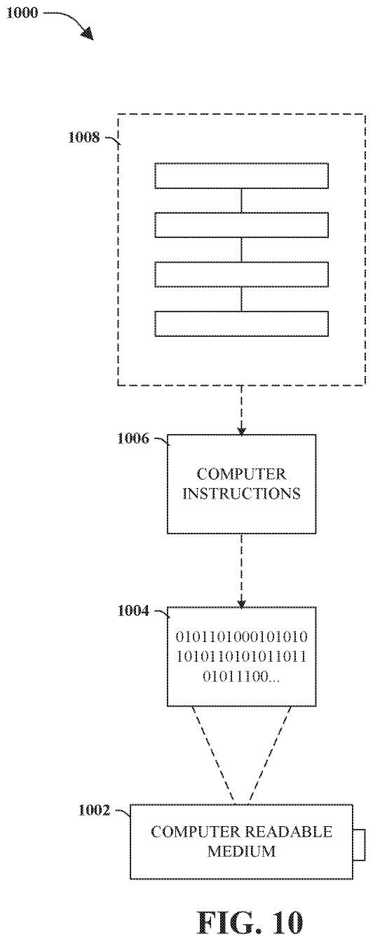

An embodiment of a computer-readable medium or a computer-readable device devised in these ways is illustrated in FIG. 10, wherein an implementation 1000 includes a computer-readable medium 1002, such as a CD-R, DVD-R, flash drive, a platter of a hard disk drive, and so forth, on which is encoded computer-readable data 1004. The computer-readable data 1004, such as binary data including a plurality of zero's and one's as illustrated, in turn includes a set of computer instructions 1006 configured to operate according to one or more of the principles set forth herein.

In the illustrated embodiment 1000, the set of computer instructions 1006 (e.g., processor-executable computer instructions) may be configured to perform a method 1008, such as the method 800 of FIG. 8 and/or the method 900 of FIG. 9, for example. In another embodiment, the set of computer instructions 1006 may be configured to implement a system, such as the system 200 of FIG. 2 and/or the system 300 of FIG. 3, for example. Many such computer-readable media may be devised by those of ordinary skill in the art that are configured to operate in accordance with the techniques presented herein.

As used in this application, the terms “component”, “module,” “system”, “interface,” “manager,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

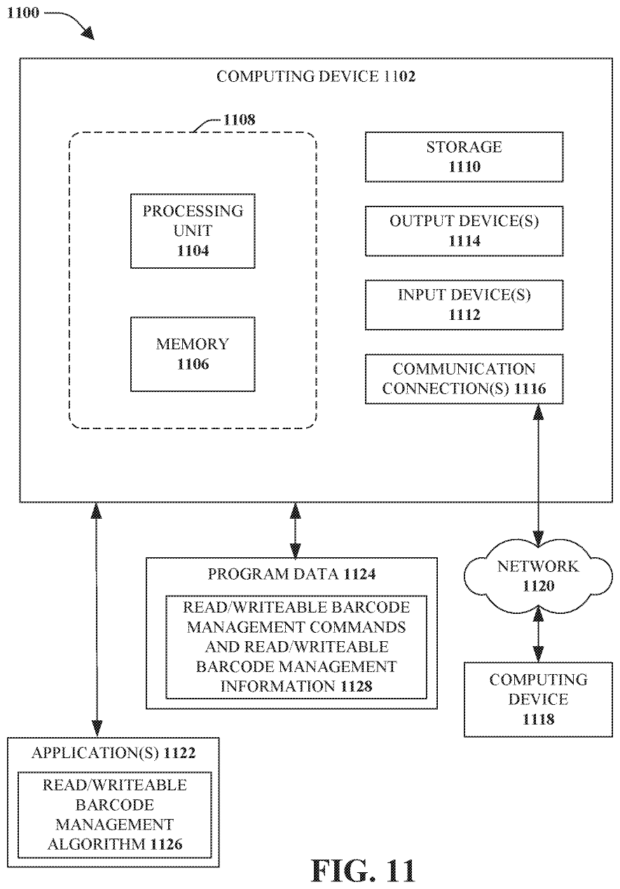

FIG. 11 and the following discussion provide a description of a suitable computing environment to implement embodiments of one or more of the aspects set forth herein. The operating environment of FIG. 11 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 11 illustrates a system 1100 that may include a computing device 1102 configured to implement one or more embodiments provided herein. In one configuration, the computing device 1102 may include at least one processing unit 1104 and at least one memory 1106. Depending on the exact configuration and type of computing device, the at least one memory 1106 may be volatile, such as RAM, non-volatile, such as ROM, flash memory, etc., or a combination thereof. This configuration is illustrated in FIG. 11 by dashed line 1108.

In other embodiments, the computing device 1102 may include additional features or functionality. For example, the computing device 1102 may include additional storage such as removable storage or non-removable storage, including, but not limited to, magnetic storage, optical storage, etc. Such additional storage is illustrated in FIG. 11 by storage 1110. In one or more embodiments, computer readable instructions to implement one or more embodiments provided herein are in the storage 1110. The storage 1110 may store other computer readable instructions to implement an operating system, an application program, etc. Computer readable instructions may be loaded in the at least one memory 1106 for execution by the at least one processing unit 1104, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries or other data retrieval protocols) for a variety of operations with respect to the information stored by the medium. It will be understood some aspects utilize cloud-based data, apps, or the like in accordance with the features, functions and benefits of the innovation.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

The computing device 1102 may include input device(s) 1112 such as keyboard, mouse, pen, voice input device, touch input device, infrared cameras, video input devices, or any other input device. Output device(s) 1114 such as one or more displays, speakers, printers, or any other output device may be included with the computing device 1102. The input device(s) 1112 and the output device(s) 1114 may be connected to the computing device 1102 via a wired connection, wireless connection, or any combination thereof. In one or more embodiments, an input device or an output device from another computing device may be used as the input device(s) 1112 and/or the output device(s) 1114 for the computing device 1102. Further, the computing device 1102 may include communication connection(s) 1116 to facilitate communications with one or more other devices, illustrated as a computing device 1118 coupled over a network 1120.

One or more applications 1122 and/or program data 1124 may be accessible by the computing device 1102. According to some implementations, the application(s) 1122 and/or program data 1124 are included, at least in part, in the computing device 1102. The application(s) 1122 may include a read/writeable barcode management algorithm 1126 that is arranged to perform the functions as described herein including those described with respect to the systems described herein. The program data 1124 may include read/writeable barcode management commands and read/writeable barcode management information 1128 that may be useful for operation with holistic tracking and monitoring of goals as described herein.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system, comprising:
a processor coupled to a memory storing instructions that when executed by the processor, cause the processor to:
link a code to a network accessible resource after the code is activated;
store content received from first and second computing devices of a first person and a second person on the network accessible resource; and
convey, for display on a display of a third computing device, the content by way of the network accessible resource after the code is read by the third computing device of a third person, wherein the third person is a target recipient of the content, and the first person and the second person are authors of the content.

2. The system of claim 1, wherein the code is a quick response (QR) code that is readable by an optical scanner associated with a computing device.

3. The system of claim 1, wherein the code is activated after the code is initially read by the first computing device of the first person.

4. The system of claim 1, wherein the content from the second person is appended to the content added by the first person.

5. The system of claim 1, the instructions further cause the processor to store a response to the content from the third person to the network accessible resource.

6. The system of claim 5, the instructions further cause the processor to notify at least one of the first person and the second person of the response.

7. The system of claim 6, the instruction further cause the processor to convey the response to at least one of the first person or the second person after the code is read by the computing device of the first person or the second person.

8. The system of claim 1, wherein access to the content is controlled by a credential of the third person.

9. The system of claim 1, wherein the code comprises an associated attribute that captures a characteristic of the code including at least one of inactive, active, recorded, public, or private.

10. The system of claim 1, wherein the content comprises one of an audio message, an image message, or a video message.

11. The system of claim 1, wherein the content comprises an electronic gift.

12. A method, comprising:
linking a code to a network accessible resource after the code is activated;
storing content received from first and second computing devices of a first person and a second person on the network accessible resource; and
conveying, for display on a display of a third computing device, the content by way of the network accessible resource after the code is read by the third computing device of a third person, wherein the third person is a target recipient of the content, and the first person and the second person are authors of the content.

13. The method of claim 12, wherein the code is activated after an initial optical scan of the first person by way of the first computing device.

14. The method of claim 12, further comprising storing a response to the content from the third person to the network accessible resource.

15. The method of claim 14, further comprising notifying at least one of the first person or the second person of the response.

16. The method of claim 14, further comprising conveying the response to at least one of the first person and the second person after the code is read by the computing device of the first person or the second person.

17. The method of claim 12, further comprising controlling access to the content by way of a credential associated with the third person.

18. A method of barcode-based communication, comprising:
executing, on a processor, instructions that cause the processor to perform operations comprising:
linking an available network-accessible data store to a two-dimensional matrix barcode after initial reading by a first person by way of a first computing device, where subsequent reading accesses the data store;
loading content received by the first person to the data store;
adding content received by a second person to the data store after a reading of the barcode by the second person by way of a second computing device; and
conveying, for display on a display of a third computing device, the content by way of the network-accessible data store after the barcode is read by a third computing device of a third person, wherein the third person is a target recipient of the content, and the first person and the second person are authors of the content.

19. The method of claim 18, the operations further comprising:
storing a response to the content from the third person to the network-accessible data store; and
conveying, for display on a computing device display, the response to at least one of the first person and the second person after the barcode is read by the computing device of the first person or the second person.

20. The method of claim 19, the operations further comprise notifying at least one of the first person and the second person of the response.
